(19) United States
(12) Patent Application Publication
(10) Pub. No.: US 2012/0279749 A1
(43) Pub. Date: Nov. 8, 2012

(54) CABLE CLOSURE

(76) Inventors: Stefan Badura, Menden (DE); Mike Breuer-Heckel, Dortmund (DE); Lars Kittler, Schwerte (DE)

(21) Appl. No.: 13/463,460

(22) Filed: May 3, 2012

(30) Foreign Application Priority Data
May 5, 2011 (EP) 11164935.6

(51) Int. Cl. H02G 15/10

(52) U.S. Cl. 174/92

(57) ABSTRACT

A cable closure, having a housing delimiting an interior and sealing off the cable closure toward the outside, said housing comprising a covering body, said covering body comprising shells and providing on mutually opposite sides cable insertion regions for inserting cables into said interior and/or for passing cables out of said interior of the cable closure, wherein compressible and/or deformable sealing elements are positioned proximal to said cable insertion regions, and wherein said shells can be locked together by a closing mechanism, whereby said shells are hinged together at first sides so that said shells can be pivoted relative to each other when opening and closing the cable closure, and that the closing mechanism can be used to lock said shells to each other at second sides of the same when said shells are in the closed position.

### CROSS-REFERENCE TO RELATED APPLICATIONS

This application claims the benefit of priority under 35 U.S.C. §119 of European Patent Application Serial No. 11164935 filed on May 5, 2011, the content of which is relied upon and incorporated herein by reference in its entirety.

### BACKGROUND

1. Field of the disclosure

The present patent application relates to cable closures, and particularly to cable closures suitable for both aerial and sub-surface applications.

2. Technical field

Cable closures are used in telecommunications cable networks for protecting spliced joints at connection points between two telecommunications cables and for protecting branch points or splitting points of telecommunications cables. In this case, the cable closures need to ensure the continuity of the telecommunications cables as though the telecommunications cables had not been interrupted.

The product catalog “Accessories for Fiber Optic Networks”, Edition 1, page 75, Corning Cable Systems, 2001 discloses cable closures firstly in the form of inline cable closures and secondly in the form of dome cable closures, which all have a housing which defines an interior of the cable closure and seals off the interior thereof from the outside. Conventionally, assemblies for connecting, namely for splicing, telecommunications conductors guided in telecommunications cables are arranged in the interior defined by the housing of the cable closure.

In the case of cable closures in the form of dome cable closures, the housing is formed by a dome-like covering body and a sealing body, the sealing body defining cable insertion regions, which are sealed off on one side of the dome-like covering body and via which all of the cables can be inserted into the interior of the cable closure.

In the case of cable closures in the form of inline cable closures, cable insertion regions which are sealed off on two opposite sides of the covering body are formed for inserting cables into the interior of the cable closure, with the result that inline cable closures can be installed in one line with the cables.

DE 20 2010 006 582 U1 discloses an inline cable closure, having a housing, which delimits an interior of the cable closure and seals off the cable closure toward the outside, said housing comprising a covering body, said covering body comprises shells and provides on mutually opposite sides of the same cable insertion regions for inserting cables into said interior of the cable closure and/or for passing cables out of said interior of the cable closure. Compressible and/or deformable sealing elements are positioned at said mutually opposite sides of said covering body in the region of said cable insertion regions of said shells, wherein each of said sealing elements is positioned between barrier walls of the respective shell, namely between a barrier wall facing the interior of the cable closure and a barrier wall remote from the interior of the cable closure.

According to DE 20 2010 006 582 U1 the inline cable closure comprises a closing mechanism by which the shells can be locked together in a closed status of the cable closure, whereby said closing mechanism comprises clip-like fastening elements and fastening screws extending through the two shells.

No admission is made that any reference cited herein constitutes prior art. Applicant expressly reserves the right to challenge the accuracy and pertinency of any cited documents.

### SUMMARY

Against this background, the present disclosure provides a novel cable closure having improved closing mechanism.

This is accomplished by the feature that said shells are hinged together at first sides of the same so that said shells can be pivoted relative to each other when opening and closing the cable closure, whereby the closing mechanism can be used to lock said shells to each other at second sides of the same when said shells are in the closed position.

Preferably, the closing mechanism comprises at least one knee lever like locking segment having a locking hook and a locking link, whereby the locking link is with a first end pivotably attached to a first one of said shells, and whereby the locking link is with a second end pivotably attached to a first end of the locking hook, whereby a second end of the locking hook engages behind an edge of the respective second side of a second one of said shells when said shells are in the closed position and locked to each other.

Additional features will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

Exemplary embodiments of the disclosure will be explained in more detail, without any restriction being imposed, with reference to the drawings, in which:

FIG. 1 is a perspective view of an exemplary embodiment of a cable closure in the form of an inline cable closure in a closed, completely locked status of the same;

FIG. 2 is a perspective view of the inline cable closure of FIG. 1 in a closed, partially un-locked status of the same;

FIG. 3 is a perspective view of the inline cable closure of FIG. 1 in a closed, completely un-locked status of the same;

FIG. 4 is a perspective view of the inline cable closure of FIG. 1 in an opened status of the same;

FIG. 5 is a perspective cross-section through the inline cable closure of FIG. 1 in a closed, partially un-locked status of the same;

FIG. 6 is another perspective cross-section through the inline cable closure of FIG. 1;

FIG. 7 is another perspective cross-section through the inline cable closure of FIG. 1; and

FIG. 8 is a detail of the closing mechanism of the inline cable closure of FIG. 1.

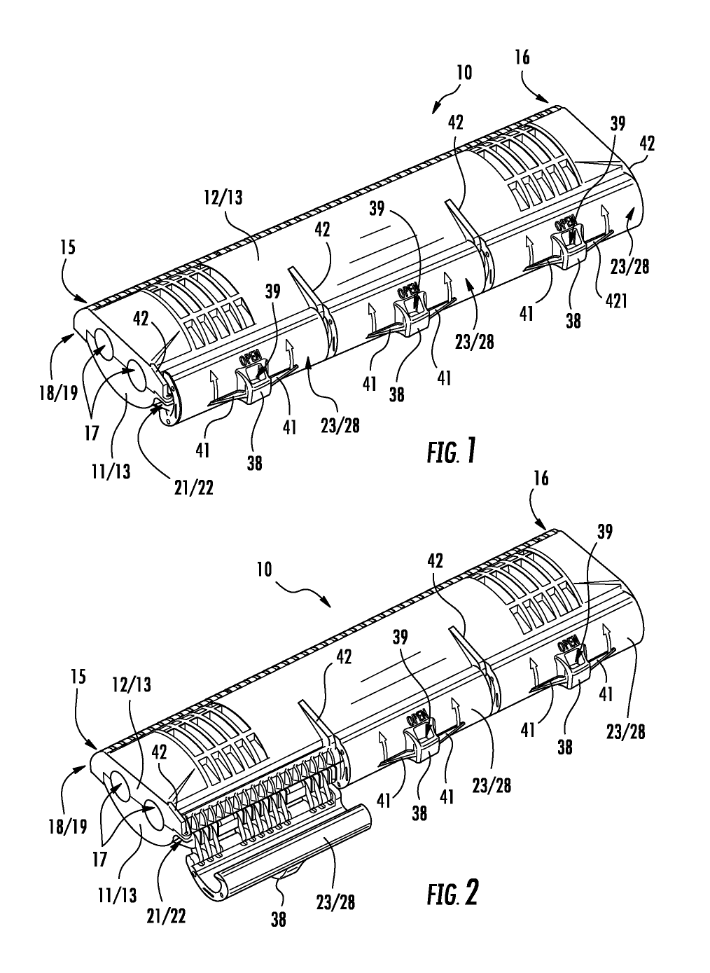

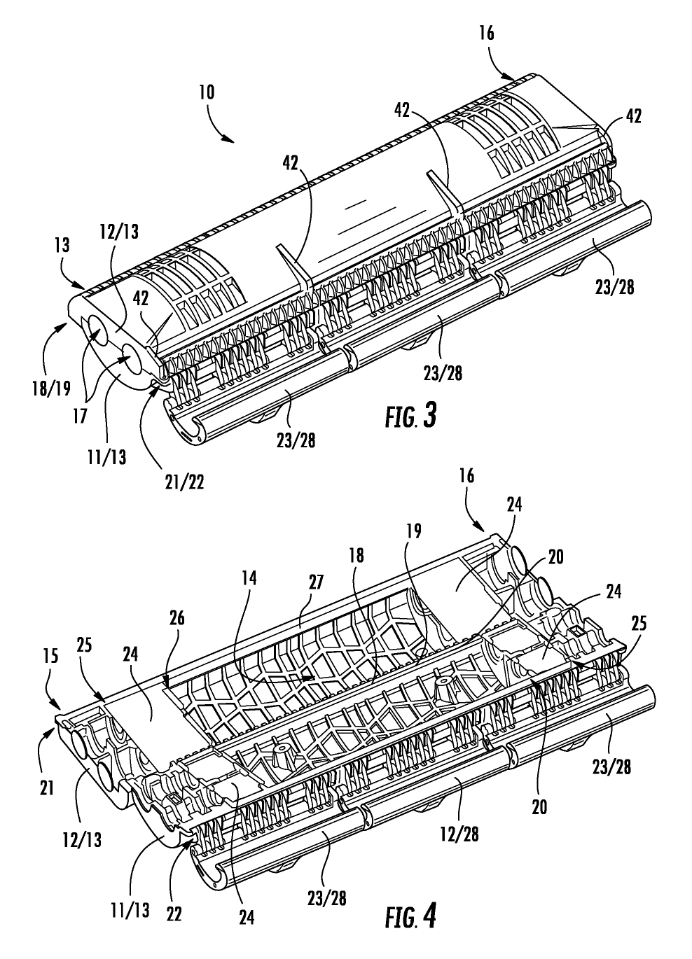

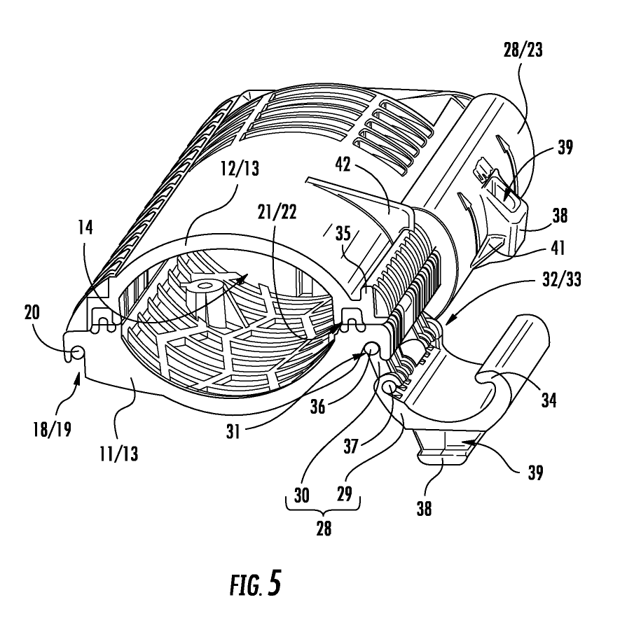

The present disclosure relates to a cable closure 10, which in the exemplary embodiment shown is an inline cable closure comprises a housing which is formed by a covering body 13 composed of two shells 11 and 12.

In the exemplary embodiment shown, the shells 11 and 12 are half-shells and the half-shell 11 is a so-called lower shell and the half-shell 12 is a so-called upper shell of the covering body 13, which together define an interior 14 of the inline cable closure 10.

Cable insertion regions 17 are formed on mutually opposite sides 15 and 16 of the inline cable closure 10 or the covering body 13, with it being possible for cables to be inserted into the interior 14 of the inline cable closure 10 or passed out of said interior. In the exemplary embodiment shown, in each case two cable insertion regions 17 for inserting in each case one cable into the interior 14 of the inline cable closure 10 are formed on both mutually opposite sides 15 and 16 of the covering body 13.

In the shown embodiment, the two half-shells 11 and 12 are hinged together at first sides 18, 19 of the same. In the example embodiment said first sides 18, 19 are longitudinal sides of the shells 11, 12. The half-shells 11 and 12 can be pivoted with respect to each other around a hinge 20 by which said two half-shells 11 and 12 are fixed to each other at said first longitudinal sides 18, 19 of the same. When the inline cable closure 10 is closed, second sides 21, 22 of the two half-shells 11 and 12 can be locked to each other by a closing mechanism 23. In the example embodiment said second sides 21, 22 are other longitudinal sides of the shells 11, 12. The closing mechanism 23 will be described below in greater detail.

In order to ensure that the cables to be inserted into the interior 14 of the inline cable closure 10 via the cable insertion regions 17 are sealed off, compressible and/or deformable sealing elements 24, which are each arranged between barrier walls 25 and 26, are positioned in the region of both mutually opposite sides 15 and 16 of the covering body 13 of the inline cable closure 10 on which the cable insertion regions 17 are formed, both in the region of the lower half-shell 11 and in the region of the upper half-shell 12.

A first barrier wall 25 is in each case, namely on both mutually opposite sides 15 and 16 in the region of the lower half-shell 11 and in the region of the upper half-shell 12, remote from the interior 14 of the inline cable closure 10 while a second barrier walls 26 is in each case facing the interior 14 of the cable closure 10.

Each of said barrier walls 25 and 26, namely both the barrier walls 25 remote from the interior 14 and the barrier walls 26 facing the interior 14, extends transversely with respect to an insertion direction of the cable insertion regions 17.

As shown in FIG. 2, the compressible and/or deformable sealing elements 24 of the upper half-shell 12, which are associated with the cable insertion regions 17, are coupled via compressible and/or deformable sealing elements 27, which run parallel to longitudinal sides 18, 22 of the upper half-shell 12. As a result, an annular, closed sealing region is formed by the sealing elements 24 and 27 in the region of the upper half-shell 12. Possibly, an analogous sealing region can also be formed in the region of the lower half-shell 11.

The compressible and/or deformable sealing elements 24 and possibly 27 are preferably gel-like sealing elements, for example polyurethane gels or silicone gels. Such gel-like sealing elements are deformable and can be compressible.

It is also possible to use sealing elements 24 which are partially composed of different materials, for example from a deformable, gel-like sealing material and from a foam-like compressible sealing material.

As mentioned above, said half-shells 11, 12 of said covering body 13 are hinged together at said first longitudinal sides 18, 19 so that said two half-shells 11, 12 can be pivoted relative to each other around an axis or hinge 20 running parallel to said longitudinal sides 18, 19 when opening and closing the cable closure 10.

The closing mechanism 23 can be used to lock said half-shells 11, 12 of said covering body 13 to each other at second longitudinal sides 21, 22 of the same when said half-shells 11, 12 of said covering body 13 are in the closed position.

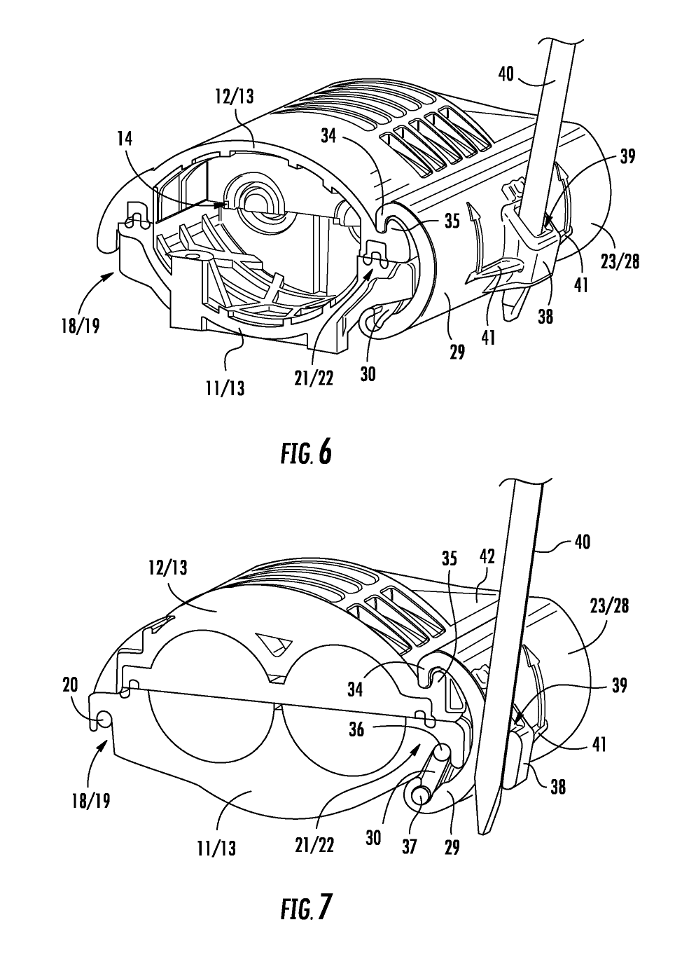

The closing mechanism 23 comprises at least one knee lever like locking segment 28 each having a locking hook 29 and a locking link 30 (see FIGS. 5 and 8). In the shown embodiment the closing mechanism 23 comprises three knee lever like locking segments 28. The three knee lever like locking segments 28 are being positioned side by side and are individually lockable and un-lockable.

The locking link 30 of the respective knee lever like locking segment 28 is with a first end 31 pivotably attached to a first one of said half-shells 11, namely in the shown embodiment to the lower half-shells 11. The locking link 30 of the respective knee lever like locking segment 28 is with a second end 32 pivotably attached to a first end 33 of the respective locking hook 29, whereby a second end 34 of the locking hook 29 engages behind an edge 35 of the respective second side of a second one of said half-shells 12, namely in the shown embodiment behind an edge 35 of the upper half-shell 12, when said half-shells 11, 12 are in the closed position and locked to each other.

The locking link 30 of the respective knee lever like locking segment 28 can be pivoted with respect to the first one of said half-shells 11, namely in the shown embodiment with respect to the lower half-shells 11, around an axis or hinge 36 assigned to the first end 31 of the locking link 30.

Further on, the locking link 30 of the respective knee lever like locking segment 28 can be pivoted with respect to the locking hook 29 around an axis or hinge 37 assigned to the second end 32 of the locking link 30.

Said axes or hinges 36, 37 run both in parallel to said longitudinal sides 18, 19, 21, 22 of the half-shells 11, 12.

For locking such a knee lever like locking segment 28 the locking hook 29 and locking link 30 of the same are pivoted in such a way that the second end 34 of the locking hook 29 engages behind the edge 35 of said upper half-shell 12 and then the locking hook 29 and locking link 30 are pivoted in a certain direction, in the shown embodiment in a clockwise direction, while the second end 34 of the locking hook 29 still engages behind said edge 35. For un-locking the same the locking hook 29 and locking link 30 are pivoted in an opposite direction, in the shown embodiment in a counterclockwise direction.

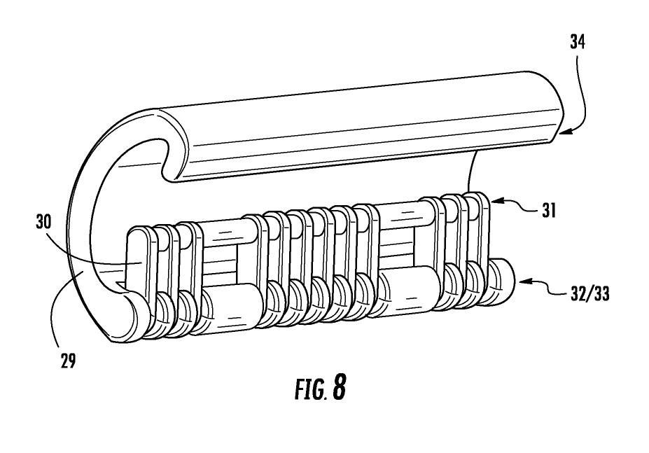

In order to provide easily the locking or un-locking forces needed for such a movement of locking hook 29 and locking link 30 while the second end 34 of the locking hook 29 engages behind said edge 35, the locking hook 29 of the respective knee lever like locking segment 28 comprises a protrusion 38 with an through hole 39 for receiving a leverage tool 40 like a screw driver for locking and/or un-locking the respective knee lever like locking segment 28 (see FIGS. 6 and 7).

The looking force can applied by said leverage tool 40 when the same is inserted into said through hole 39 by pushing or pulling said leverage tool 40 in the first direction, e.g. the clockwise direction. The un-looking force can applied by said leverage tool 40 when the same is inserted into said through hole 39 by pushing or pulling said leverage tool in the second direction, e.g. the counterclockwise direction.

Flanges 41 of said protrusions 38 provide a greater mechanical stiffness for said protrusions 38. The flanges 41 are positioned on both sides of each protrusion 38 and run perpendicular to the direction of the respective through hole 39 and in parallel to the longitudinal sides 18, 19, 21, 22 of the half-shells 11, 12.

It is possible to remove or eject dirt or stones from the said through hole 39 by using said leverage tool 40 when needing access to an inline cable closure 10 installed in the field.

The second one of said half-shells 12, namely in the shown embodiment to the upper half-shells 12, comprises ribs 42 running perpendicular to the second longitudinal side 21 of the same an both sides of the or each knee lever like locking segment 28. These ribs 42 as well as the design of the closing mechanism 23 protect the closing mechanism 23 against damages and accidental un-locking/opening when using a spade to dig out a cable closure installed in the field below ground. Due to the ribs 42 a spade will slide over the closing mechanism 23.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

List of reference numerals

10 inline cable closure

11 shell/lower half-shell

12 shell/upper half-shell

13 covering body

14 interior

15 side

16 side

17 cable insertion region

18 longitudinal side

19 longitudinal side

20 hinge

21 longitudinal side

22 longitudinal side

23 closing mechanism

24 sealing element

25 barrier wall

26 barrier wall

27 sealing element

28 knee lever like locking segment

29 locking hook

30 locking link

31 first side

32 second side

33 first side

34 second side

35 edge

36 hinge

37 hinge

38 protrusion

39 through hole

40 leverage tool

41 flange

42 rib

1. A cable closure, comprising:
a housing, the housing delimiting an interior of the cable closure and sealing the cable closure toward the outside, the housing including a covering body, the covering body including shells and providing on mutually opposite sides of the housing cable insertion regions for inserting cables into the interior of the cable closure and for passing cables out of the interior of the cable closure, wherein deformable sealing elements are positioned at the mutually opposite sides of the covering body in the region of the cable insertion regions of the shells, and wherein the shells can be locked together in a closed status of the cable closure by at least one closing mechanism,
wherein the shells are hinged together at first sides so that the shells can be pivoted relative to each other when opening and closing the cable closure, and that the at least one closing mechanism can be used to lock the shells to each other at second sides of the shells when the shells are in the closed position.

2. The cable closure of claim 1, wherein the at least one closing mechanism comprises at least one knee lever-like locking segment having a locking hook and a locking link.

3. The cable closure of claim 2, wherein the locking link is pivotably attached to a first one of the shells at a first end, and wherein the locking link is pivotably attached to a first end of the locking hook at a second end, whereby a second end of the locking hook engages behind an edge of the respective second side of a second one of the shells when the shells are in the closed position and locked to each other.

4. The cable closure of claim 3, wherein the locking link of the at least one knee lever-like locking segment is pivotable with respect to the first one of the shells and with respect to the locking hook, both around a hinge running along the sides of the shells.

5. The cable closure of claim 2, wherein the locking hook of the at least one knee lever-like locking segment comprises a protrusion with a through hole for receiving a leverage tool for locking and un-locking the respective knee lever-like locking segment.

6. The cable closure of claim 5, wherein a locking force is applied by the leverage tool when the leverage tool is inserted into the through hole in a first direction, and that an un-locking force is applied by the leverage tool when the leverage tool is inserted into the through hole in a second direction.

7. The cable closure of claim 1, wherein the second one of the shells comprises ribs running perpendicular to the second side of the second one of the shells on both sides of the at least one closing mechanism.

8. The cable closure of claim 1, wherein the closing mechanism comprises at least two knee lever-like locking segments being positioned side by side and being individually lockable and un-lockable.

9. A cable closure, comprising:
a housing, the housing delimiting an interior of the cable closure and sealing the cable closure toward the outside, the housing including a covering body, the covering body including shells and providing on mutually opposite sides of the housing cable insertion regions for inserting cables into the interior of the cable closure and for passing cables out of the interior of the cable closure, wherein deformable sealing elements are positioned at the mutually opposite sides of the covering body in the region of the cable insertion regions of the shells, and wherein the shells can be locked together in a closed status of the cable closure by a closing mechanism,
wherein the shells are hinged together at first sides so that the shells can be pivoted relative to each other when opening and closing the cable closure, and that the closing mechanism can be used to lock the shells to each other at second sides of the shells when the shells are in the closed position,
wherein the closing mechanism comprises at least one knee lever-like locking segment having a locking hook and a locking link.

10. The cable closure of claim 9, wherein the locking link is pivotably attached to a first one of the shells at a first end, and wherein the locking link is pivotably attached to a first end of the locking hook at a second end, whereby a second end of the locking hook engages behind an edge of the respective second side of a second one of the shells when the shells are in the closed position and locked to each other.

11. The cable closure of claim 10, wherein the locking link of the at least one knee lever-like locking segment is pivotable with respect to the first one of the shells and with respect to the locking hook, both around a hinge running along the sides of the shells.

12. The cable closure of claim 9, wherein the locking hook of the at least one knee lever-like locking segment comprises a protrusion with a through hole for receiving a leverage tool for locking and un-locking the respective knee lever-like locking segment.

13. The cable closure of claim 12, wherein a locking force is applied by the leverage tool when the leverage tool is inserted into the through hole in a first direction, and that an un-locking force is applied by the leverage tool when the leverage tool is inserted into the through hole in a second direction.

14. The cable closure of claim 9, wherein the second one of the shells comprises ribs running perpendicular to the second side of the second one of the shells on both sides of the at least one closing mechanism.

15. The cable closure of claim 9, wherein the closing mechanism comprises at least two knee lever-like locking segments being positioned side by side and being individually lockable and un-lockable.

16. A cable closure, comprising:
a housing, the housing delimiting an interior of the cable closure and sealing the cable closure toward the outside, the housing including a covering body, the covering body including shells and providing on mutually opposite sides of the housing cable insertion regions for inserting cables into the interior of the cable closure and for passing cables out of the interior of the cable closure, wherein deformable sealing elements are positioned at the mutually opposite sides of the covering body in the region of the cable insertion regions of the shells, and wherein the shells can be locked together in a closed status of the cable closure by a closing mechanism,
wherein the shells are hinged together at first sides so that the shells can be pivoted relative to each other when opening and closing the cable closure, and that the closing mechanism can be used to lock the shells to each other at second sides of the shells when the shells are in the closed position,
wherein the closing mechanism comprises at least one knee lever-like locking segment having a locking hook and a locking link,
wherein the locking link is pivotably attached to a first one of the shells at a first end, and wherein the locking link is pivotably attached to a first end of the locking hook at a second end, whereby a second end of the locking hook engages behind an edge of the respective second side of a second one of the shells when the shells are in the closed position and locked to each other,
wherein the second one of the shells comprises ribs running perpendicular to the second side of the second one of the shells on both sides of the at least one closing mechanism.
